(19) United States
(12) Patent Application Publication
(10) Pub. No.: US 2014/0152659 A1
(43) Pub. Date: Jun. 5, 2014

(54) GEOSCIENCE DATA VISUALIZATION AND IMMERSION EXPERIENCE

(71) Applicants: Preston H. Davidson, Houston, TX (US); David W. Green, Richmond, TX (US); Sebastian E. Ramirez, Houston, TX (US); William W. Scott, The Woodlands, TX (US); Joel W. Tarver, Houston, TX (US); Doron Hetz, Houston, TX (US)

(72) Inventors: Preston H. Davidson, Houston, TX (US); David W. Green, Richmond, TX (US); Sebastian E. Ramirez, Houston, TX (US); William W. Scott, The Woodlands, TX (US); Joel W. Tarver, Houston, TX (US); Doron Hetz, Houston, TX (US)

(21) Appl. No.: 13/692,298

(22) Filed: Dec. 3, 2012

(51) Int. Cl. G06T 17/00

(52) U.S. Cl. CPC G06T 17/00
USPC 345/420

(57) ABSTRACT

A method for presenting measurements of properties of a subsurface material to a user includes: conveying a carrier through a borehole penetrating the subsurface material; performing a plurality of measurements of multiple properties of the subsurface material at multiple depths in the borehole using a plurality of downhole tools disposed at the carrier; constructing, with a processor, a three-dimensional mathematical model of the subsurface material using the plurality of measurements, the model having data from the plurality of measurements of the multiple properties; receiving, with the processor, an input from a user directing the processor to generate a three-dimensional image of the subsurface material as seen from a virtual viewer-window viewing the model, the input having a three-dimensional position and three-dimensional viewing direction of the virtual-viewer window within the model; generating the three-dimensional image with the processor; and displaying the generated three-dimensional image on a display.

### BACKGROUND

Earth formations may be used for various purposes such as hydrocarbon production, geothermal production, and carbon dioxide sequestration. In order to efficiently use an earth formation, the formation is characterized by performing measurements of many different properties. These measurements are typically performed by different logging tools conveyed through a borehole penetrating the formation. A formation property is measured and recorded along with the depth in the borehole at which the property is measured as a downhole tool is conveyed through the borehole. The measurements and the corresponding depths at which each measurement was obtained are used to produce a log of the property. The log is generally a graph of a value of the property versus depth, typically presented in a vertical format.

Many logs are typically produced to a formation being characterized. These logs may be used by users, such as drilling operators and geological-analysts, in order to make important decisions related to efficiently using costly resources. Some of these decisions must be made in a short amount of time. Unfortunately, the user may be inundated with many different logs and be under time pressure to correctly interpret those logs before making decisions. Hence, it would be appreciated in the drilling and geo-physical exploration industries if logging data could be presented to a user in a format conducive to interpreting that data in a short amount of time.

### BRIEF SUMMARY

Disclosed is a method for presenting measurements of properties of a subsurface material to a user. The method includes conveying a carrier through a borehole penetrating the subsurface material and performing a plurality of measurements of multiple properties of the subsurface material at multiple depths in the borehole using a plurality of downhole tools disposed at the carrier. The method further includes constructing, with a processor, a three-dimensional mathematical model of the subsurface material using the plurality of measurements, the model having data from the plurality of measurements of the multiple properties. The method further includes receiving, with the processor, an input from a user directing the processor to generate a three-dimensional image of the subsurface material as seen from a virtual viewer-window viewing the model, the input having a three-dimensional position and three-dimensional viewing direction of the virtual-viewer window within the model. The method further includes generating the three-dimensional image with the processor and displaying the generated three-dimensional image on a display.

Also disclosed is an apparatus for presenting measurements of properties of a subsurface material to a user. The apparatus includes a carrier configured to be conveyed through a borehole and a plurality of downhole tools disposed at the carrier, the plurality of downhole tools being configured to perform a plurality of measurements of multiple properties of the subsurface material. The apparatus further includes a processor configured to (a) construct a three-dimensional mathematical model of the subsurface material using the plurality of measurements, the model having data from the plurality of measurements of the multiple properties and (b) generate from a virtual viewer-window perspective a three-dimensional image of the subsurface material using the model. The apparatus further includes an input device configured to provide input to the processor from the user directing the processor to generate the three-dimensional image of the subsurface material, the input having a position and three-dimensional viewing direction of the virtual-viewer window perspective within the subsurface material. The apparatus further includes a display configured to display the three-dimensional image to the user.

### BRIEF DESCRIPTION OF THE DRAWINGS

The following descriptions should not be considered limiting in any way. With reference to the accompanying drawings, like elements are numbered alike:

FIG. 1 illustrates a cross-sectional view of an exemplary embodiment of downhole tools disposed in a borehole penetrating the earth;

FIG. 2 depicts aspects of a mathematical model of a subsurface material constructed from measurement data obtained from the downhole tools;

FIG. 3 depicts aspects of a virtual viewer-window configured to view aspects of the mathematical model;

FIG. 4 depicts aspects of positioning and orienting the virtual viewer window; and

FIG. 5 is a flow chart for a method for presenting measurements of properties of a subsurface material to a user.

### DETAILED DESCRIPTION

A detailed description of one or more embodiments of the disclosed apparatus and method presented herein by way of exemplification and not limitation with reference to the Figures.

Disclosed are method and apparatus for performing a plurality of measurements of different properties of a subsurface material and constructing a three-dimensional mathematical model of the subsurface material using the plurality of measurements. A user can guide a virtual viewer-window through the model to observe subsurface material properties at a position and orientation direction selected by the user. In addition, the model can portray movement of subsurface material such as by animation according to the laws of physics.

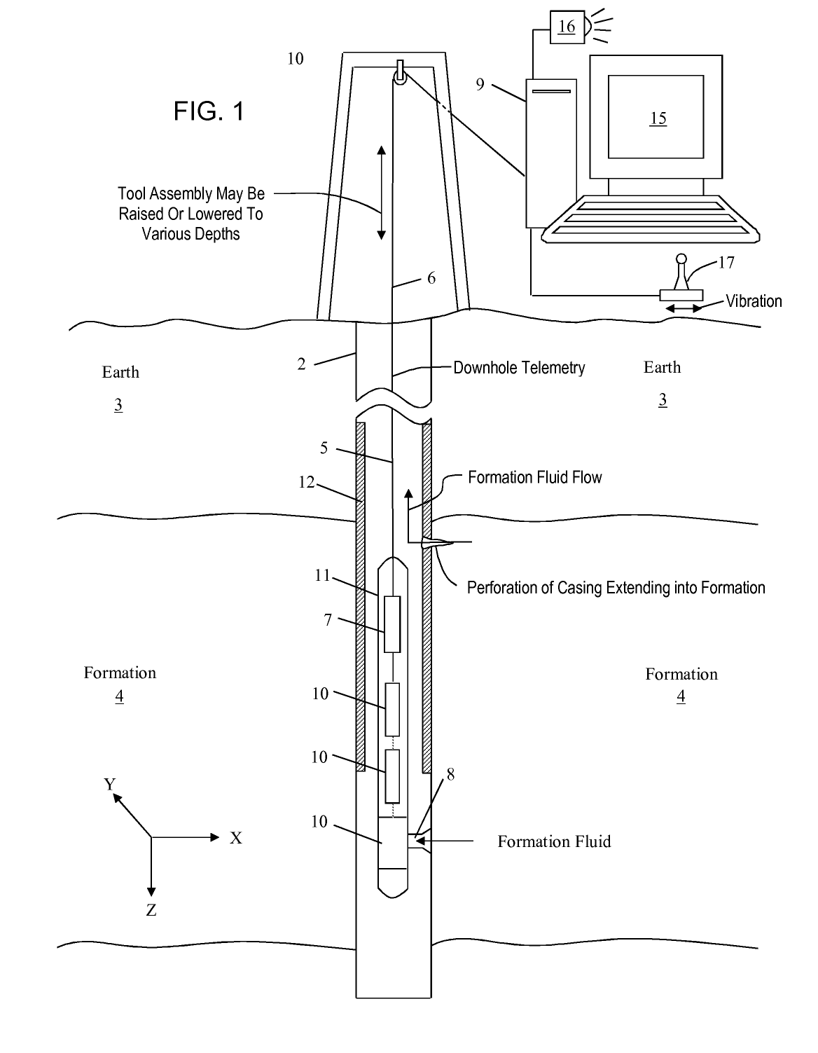

FIG. 1 illustrates a cross-sectional view of an exemplary embodiment of a plurality of downhole tools 10 disposed in a borehole 2 penetrating the earth 3, which includes an earth formation 4. Lining the borehole 2 is a casing 12, which may be cemented to the borehole wall. The term “subsurface material” may be used to refer to any material below the surface of the earth 3, such as the formation 4, the casing 12, casing cement, and a formation fluid or solid as non-limiting examples. A downhole tool assembly 11 containing the downhole tools 10 is conveyed through the borehole 2 by a carrier 5. In the embodiment of FIG. 1, the carrier is an armored wireline 6. Besides supporting the sonde 11, the wireline 6 can provide communications between the downhole tools 10 and a computer processing system 9 disposed at the surface of the earth 3. Communications can include sending measurements uphole to the computer processing system 9 of commands downhole to the downhole tools 10. In order to operate the downhole tools 10, process measurement data, and/or provide a communications interface with the surface computer processing system 9, the tool assembly 11 includes downhole electronics 7. The operating, processing, and display functions of the disclosure may be performed by the downhole electronics 7, the computer processing system 9, or a combination thereof. In an alternative embodiment referred to as logging-while-drilling (LWD) or measurement-while-drilling (MWD), the carrier 5 can be a drill string or drill tubular.

As illustrated in FIG. 1, the computer processing system 9 includes a display 15 for providing visual output, a speaker 16 for providing audio output, and a vibrating joy stick controller 17 for providing input via the joy stick and output via vibrations, which may be experienced by a user.

Several different types of downhole tools 10 may be used to characterize subsurface materials. The downhole tools 10 may be configured to perform measurements of various properties of the subsurface materials a one of more depths in the borehole 2. Logs of measurement values versus borehole depth of the measurements may be provided for the various properties. The term “borehole depth” may also include a distance into or position in the borehole for boreholes deviated from a vertical orientation.

Non-limiting embodiments of the downhole tools 10 are now discussed. The downhole tools 10 may include a temperature sensor, a pressure sensor, a pH sensor, a magnetic field or flux sensor, a flow sensor, a flow velocity sensor, a gamma ray detector, a spectrometer configured to identify one or more chemical elements, and a flexural mechanical resonator configured to viscosity or density of a fluid or certain gases diffused out of a fluid sample. It can be appreciated that these sensors and detectors may be configured to sense subsurface material properties from within the borehole or from a subsurface material sample extracted into the corresponding tool 10 such as by using a probe 8 illustrated in FIG. 1. The shape of the borehole 2 may be measured by a borehole caliper tool as the caliper tool is conveyed through the borehole 2. In one or more embodiments, the caliper tool is a multi-finger tool (not shown) having multiple extendable fingers that are configured to contact the borehole wall along the circumference of the borehole wall. The position of each finger is measured to measure the cross-sectional shape of the borehole 2. An acoustic tool configured to transmit and receive acoustic energy may also be used to measure the shape of the borehole 2 or to measure the acoustic resistance of a subsurface material. The downhole tool 10 can include an accelerometer to measure any deviation of the longitudinal axis of the borehole 2 from vertical. The downhole tool 10 can include a gravimeter to perform gravity measurements indicative of true vertical depth and formation density. The downhole tools 10 can include a resistivity tool configured to measure the resistivity or conductivity of a subsurface material. The resistivity tool can be a galvanic tool configured to transmit and receive electric current to and from a subsurface material or an induction tool configured to transmit and receive electromagnetic energy to and from the subsurface material. The downhole tools 10 can include a neutron tool having a neutron source configured to irradiate a subsurface material with neutrons and to detect resulting gamma rays or neutrons in order to measure porosity or density of the subsurface material. The downhole tools 10 can include a formation fluid tester configured to extract a fluid sample from the formation 4 via the probe 8 and to perform measurements on one or more properties of the fluid sample. The formation fluid tester may also be used to measure formation pressure at the borehole depth where the sample was extracted. The downhole tools 10 can include a nuclear magnetic resonance (NMR) tool configured to perform NMR measurements on a subsurface material in order to determine the porosity or NMR properties of the subsurface material. The downhole tools can include an acoustic microphone to record sounds downhole. These sounds can be related to the sounds emitted by moving subsurface material such as a subsurface material moving through the borehole 2 or a subsurface material entering the borehole 2 from the formation 4 or through a perforation in the casing 12. It can be appreciated that the sound of fluid flow (such as a gurgling noise for example) can be used to identify different flow regimes or states of flow such as very smooth or very turbulent. The downhole tools 10 can also include a camera (still or video) or imager for capturing pictures of subsurface materials in the borehole 2. In one or more embodiments, the camera can capture moving images of formation fluid flowing into the borehole 2 through a perforation in the casing 12. The images may also include an image of the perforation extending into the formation 4. It can be appreciated that the above tools or other tools can be used to characterize the casing 12 by detecting wall thickness and pitting. It can be appreciated that the above tools 10 can be included in one tool assembly 11 or distributed among a plurality of tool assemblies 11. In that the above downhole tools are known in the art, these tools are not described or illustrated in further detail.

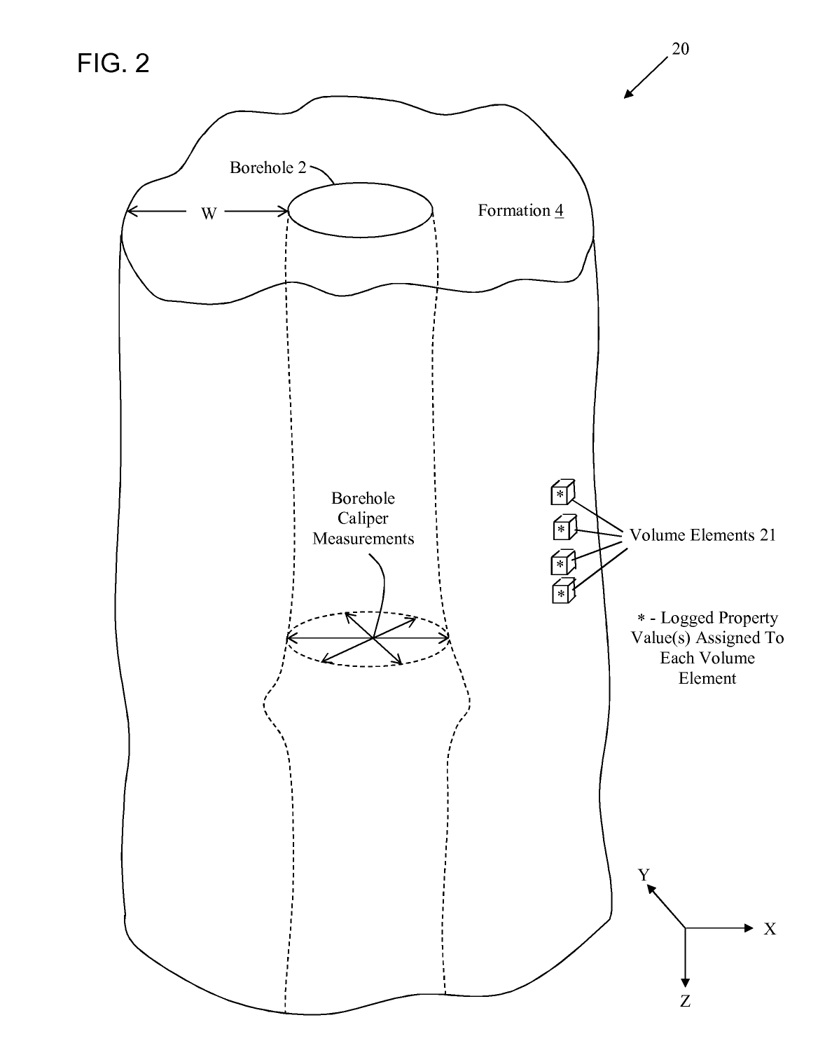

Once a plurality of measurements of different properties of a subsurface material are obtained, a mathematical model of the subsurface material can be constructed by the downhole electronics 7 and/or the computer processing system 9 using the plurality of measurements as inputs. An exemplary embodiment of a model 20 is illustrated in FIG. 2. The model 20 of the subsurface material is a mathematical representation of the subsurface material that represents the input property measurements. For example, measurements of borehole caliper can measure the cross-sectional shape of the borehole 2 at a plurality of depths in the borehole 2 while accelerometer measurements can detect deviations of the longitudinal axis of the borehole 2 to provide an accurate depiction of the borehole 2 penetrating the formation 4. In one or more embodiments, the width (W) of the formation 4 (surrounding the borehole 2) depicted in the model is related to a depth of measurement of the various properties of the formation 4. A plurality of volume elements 21 make up the formation 4 depicted in the model 20. Each volume element 21 is assigned a value for each property measured at that volume element 21. It can be appreciated that the model 20 can be updated or refined as more subsurface material property measurements are performed and entered into the model 20.

In one or more embodiments, the model 20 may calculate movement of a subsurface material according to the laws of physics so that movement of the subsurface material is accurately portrayed. For example, if a solid subsurface object collides with another object such as a borehole wall, then the model 20 will accurately portray the object bouncing off the other object according to the laws of physics. Similarly, fluid flow as sensed by a flow sensor may be used as an input to the model 20 to calculate movement of the fluid through the borehole and around non-smooth walls.

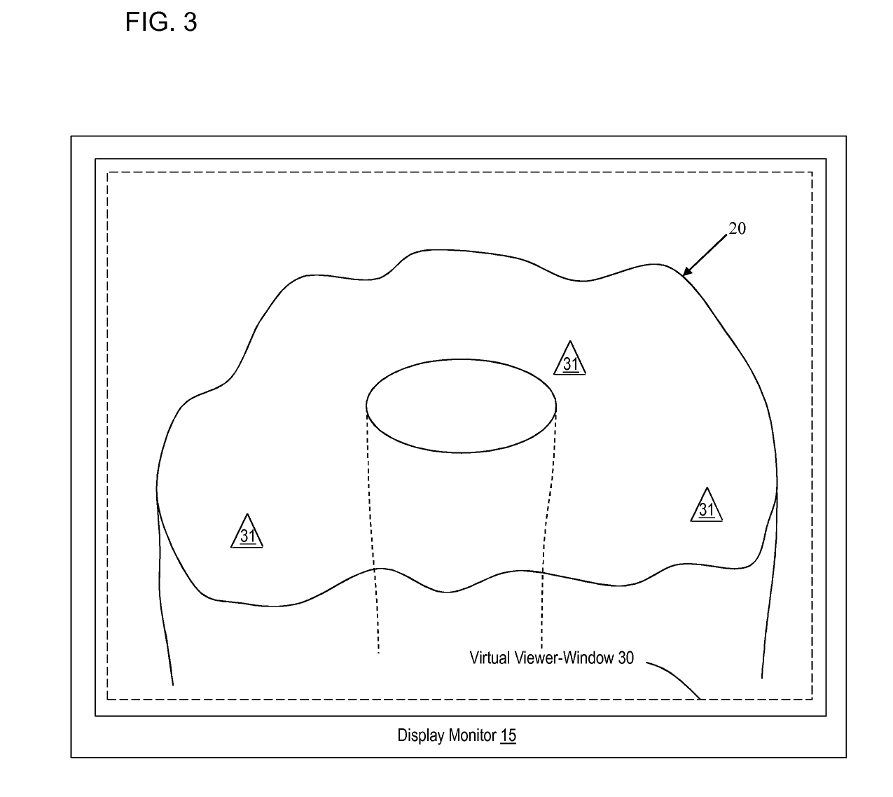

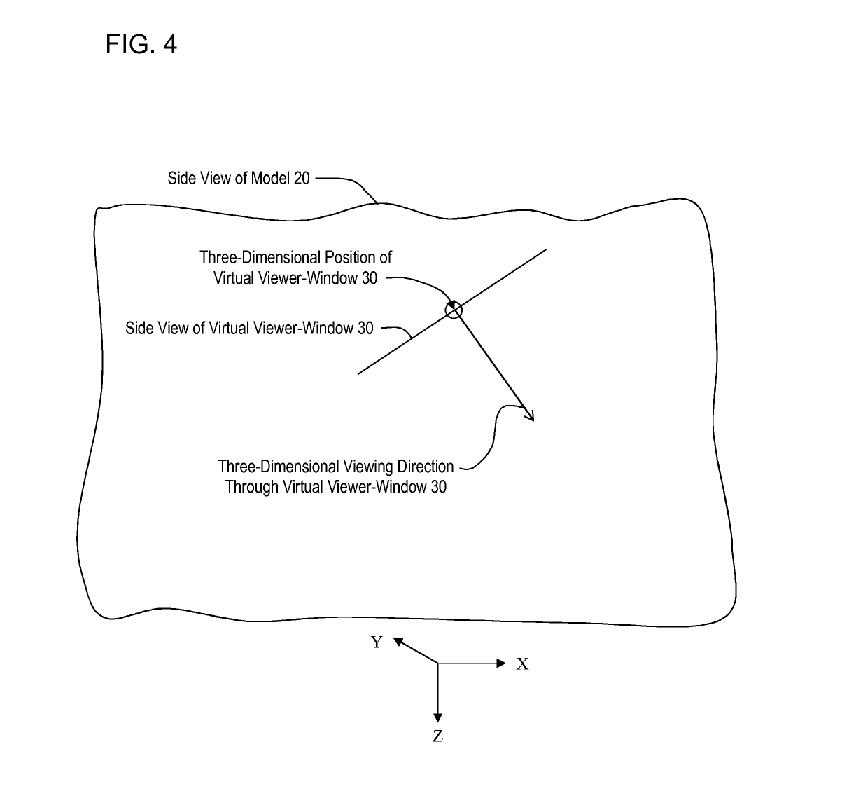

Once the model 20 is constructed, the model 20 may be viewed from a selected position and orientation (i.e. viewing direction) outside of the model 20 or from a selected position and orientation inside of the model 20 for an immersive experience. The model 20 is viewed through a virtual viewing-window 30 as illustrated in FIG. 3. A user may guide or “fly” the virtual viewing-window 30 to the selected position and orientation using a keyboard, mouse, joy stick, or other input device similar to those used in a video game. During flight or movement of the virtual viewer-window 30 or with the virtual viewer-window 30 in a static position, the computer processing system 9 determines the position of the window 30 in three-dimensional coordinates within the model 20 and the three-dimensional orientation or direction of view of the window 30 as illustrated in the side cross-sectional view in FIG. 4 in order to view properties internal to the model 20. In addition, the position of the window 30 may be placed external to the model 30 in order to view external properties of the model 30. In FIG. 4, the Y-axis is into the plane of the drawing.

The user may view subsurface material properties while the virtual viewer window 30 is stopped at a selected position and orientation or while the virtual viewer-window 30 is flying from a first position and orientation to a second position and orientation. In one or more embodiments, one or more types of properties may be assigned to a layer with all properties represented in multiple layers. The user may then select which layer or layers are to be viewed. In one or more embodiments, the subsurface material properties may be presented as alphanumeric characters. In one or more embodiments, the values of subsurface material properties may be presented as a certain color, shade of color, or texture. In one or more embodiments, the values of a subsurface material property may be represented as a flashing color or texture where the frequency of flashing relates to the value of the property. In one or more embodiments, a position of a bar graph (straight or circular) may be used to represent a value of a certain subsurface material property. In one or more embodiments, an index or glossary may be provided in the virtual viewer-window in order to help the user to interpret the representations of the subsurface material properties being used. In one or more embodiments, clickable icons 31 (i.e., hyperlinks) as illustrated in FIG. 3 may be used to provide subsurface material properties to the user. In one or more embodiments, a sound recorded at the position of the virtual viewer window may be played to the user using the speaker 16. In one or more embodiments, an actual camera picture may be superimposed on the model 30 at a position on the model 30 corresponding to the location where the picture was taken. In one or more embodiments, a video depicting movement may be superimposed on the model 30 at a position on the model corresponding to the location where the video was taken. In one or more embodiments, if W is greater than the radial depth of investigation from the borehole, then a perimeter line may be displayed around the borehole to indicate the depth of investigation for a particular property being measured. In one or more embodiments, a property of a subsurface material may be presented as a vibration of a certain magnitude or frequency to a user via a vibration output device where the magnitude or frequency corresponds to an output value of the property of interest. A non-limiting embodiment of the vibration output device is a joy stick controller having the capability to vibrate similar to that of a video game controller.

It can be appreciated that other sensory forms of output related to a property being observed may be employed. For example, various aerosols having aromas similar to that of expected subsurface materials may be individually contained. Upon detecting a certain material downhole, the computer processing system 9 may release the corresponding aerosol via pump (not shown) or solenoid (not shown) so that a user may sense the aroma and be alerted to the material just detected.

Software for constructing the model 20 and guiding or flying the virtual viewer-window 30 through the model 20 may be developed using a gaming engine such as any of those used to develop video games. The gaming engine also includes development tools to calculate and display motion of objects according to the laws of physics. Non-limiting embodiments of the gaming engine include “Unreal Engine” by Epic Games, “Unity” by Unity Technologies, “ShiVa3D” by Stonetrip, “CryEngine 3” by Crytek, “Frostbite” by DICE, “Rockstar Advanced Game Engine (RAGE)” by RAGE Technology Group, and “id Tech 5” by id Software.

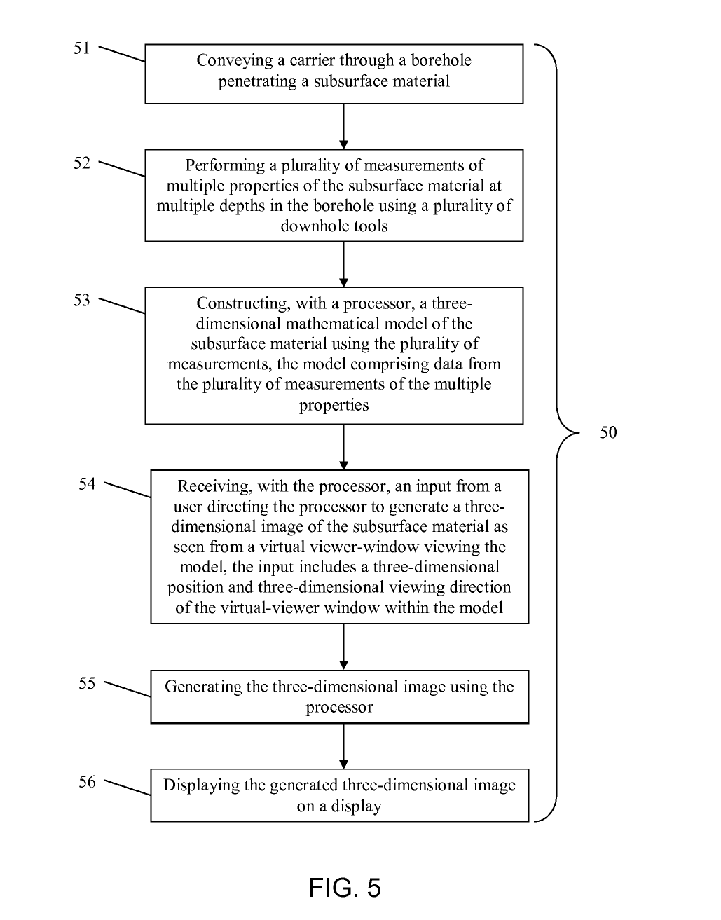

FIG. 5 presents a block diagram for a method 50 for presenting measurements of properties of a subsurface material to a user. Block 51 calls for conveying a carrier through a borehole penetrating the subsurface material. Block 52 calls for performing a plurality of measurements of multiple properties of the subsurface material at multiple depths in the borehole using a plurality of downhole tools. Block 53 calls for constructing, with a processor, a three-dimensional mathematical model of the subsurface material using the plurality of measurements. The model includes data from the plurality of measurements of the multiple properties. The model may also calculate movement of the subsurface material. Block 54 calls for receiving, with the processor, an input from a user directing the processor to generate a three-dimensional image of the subsurface material as seen from a virtual viewer-window viewing the model. The input includes a three-dimensional position and three-dimensional viewing direction of the virtual-viewer window within the model. Block 55 calls for generating the three-dimensional image using the processor. Block 56 calls for displaying the generated three-dimensional image on a display. The three-dimensional image may depict movement of the subsurface material according to the laws of physics.

While one or more embodiments have been shown and described, modifications and substitutions may be made thereto without departing from the spirit and scope of the invention. Accordingly, it is to be understood that the present invention has been described by way of illustrations and not limitation.

In support of the teachings herein, various analysis components may be used, including a digital and/or an analog system. For example, the downhole electronics 7, the computer processing system 9, or the downhole tools 10 may include digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for presenting measurements of properties of a subsurface material to a user, the method comprising:
conveying a carrier through a borehole penetrating the subsurface material;
performing a plurality of measurements of multiple properties of the subsurface material at multiple depths in the borehole using a plurality of downhole tools disposed at the carrier;
constructing, with a processor, a three-dimensional mathematical model of the subsurface material using the plurality of measurements, the model comprising data from the plurality of measurements of the multiple properties;
receiving, with the processor, an input from a user directing the processor to generate a three-dimensional image of the subsurface material as seen from a virtual viewer-window viewing the model, the input comprising a three-dimensional position and three-dimensional viewing direction of the virtual-viewer window within the model;
generating the three-dimensional image with the processor; and
displaying the generated three-dimensional image on a display.

2. The method according to claim 1, further comprising:
calculating, with the processor, a physical motion of the subsurface material using the plurality of measurements;
generating, with the processor, a moving three-dimensional image of the subsurface material; and
displaying on the display the generated moving three-dimensional image.

3. The method according to claim 2, wherein the laws of physics are used to calculate the physical motion of the subsurface material.

4. The method according to claim 2, wherein the moving subsurface material is a solid.

5. The method according to claim 2, wherein the moving subsurface material is a liquid.

6. The method according to claim 2, wherein the moving subsurface material is a gas.

7. The method according to claim 2, wherein the three-dimensional image comprises a display of data from the plurality of measurements or the calculated physical motion of the subsurface material being displayed in the image.

8. The method according to claim 7, wherein the display of data comprises alphanumeric characters, a color, a texture, or a flashing of the image or a portion of the image.

9. The method according to claim 8, wherein the flashing comprises a change in light intensity, a change in color, a change in texture, or a change in flashing frequency.

10. The method according to claim 2, playing a sound correlated to data from the plurality of measurements or the calculated physical motion of the subsurface material using a speaker.

11. The method according to claim 2, wherein the moving three-dimensional image portrays the subsurface material entering the borehole through a perforation in a casing lining the borehole.

12. The method according to claim 1, further comprising playing a sound received downhole to the user using a speaker.

13. The method according to claim 1, wherein the input comprises instructions that cause the virtual viewer-window to move continuously from a first position to a second position.

14. The method according to claim 1, wherein the processor is configured to interpolate between measurements of the same property at different borehole depths to provide a continuous three-dimensional mathematical model.

15. An apparatus for presenting measurements of properties of a subsurface material to a user, the apparatus comprising:
a carrier configured to be conveyed through a borehole;
a plurality of downhole tools disposed at the carrier, the plurality of downhole tools being configured to perform a plurality of measurements of multiple properties of the subsurface material;
a processor configured to (a) construct a three-dimensional mathematical model of the subsurface material using the plurality of measurements, the model comprising data from the plurality of measurements of the multiple properties and (b) generate from a virtual viewer-window perspective a three-dimensional image of the subsurface material using the model;
an input device configured to provide input to the processor from the user directing the processor to generate the three-dimensional image of the subsurface material, the input comprising a position and three-dimensional viewing direction of the virtual-viewer window perspective within the subsurface material; and
a display configured to display the three-dimensional image to the user.

16. The apparatus according to claim 15, wherein the processor is further configured to:
calculate a physical motion of the subsurface material using the plurality of measurements; and
generate a moving three-dimensional image of the subsurface material.

17. The apparatus according to claim 16, wherein the physical motion is calculated according to the laws of physics.

18. The apparatus according to claim 16, wherein the moving three-dimensional image portrays the subsurface material moving through the borehole.

19. The apparatus according to claim 15, wherein the input device is a joystick.

20. The apparatus according to claim 15, wherein the plurality of downhole tools comprise a temperature sensor, a pressure sensor, a galvanic resistivity tool configured to transmit and receive electric current to and from the subsurface material, an induction resistivity tool configured to transmit and receive electromagnetic energy to and from the subsurface material, an acoustic tool configured to transmit and receive acoustic energy to and from the subsurface material, a radiation detector, a neutron tool comprising a neutron source configured to irradiate the subsurface material with neutrons and to detect radiation resulting therefrom, a borehole caliper tool, a multi-finger borehole caliper tool, a magnetic field sensor, a spectrometer configured to identify chemical elements, a camera, an acoustic microphone, a flow sensor, a flow velocity sensor, a density tool, a porosity tool, a formation fluid tester configured to withdraw and test a fluid sample from a formation, a flexural mechanical resonator configured to sense viscosity or density of a liquid, a nuclear magnetic resonance tool, a pH sensor, a sensor for sensing a type of gas diffused out of a formation fluid sample, or some combination thereof.

21. The apparatus according to claim 15, wherein the input device comprises at least one vibrating joystick controller.
